(19) United States
(12) Patent Application Publication
(10) Pub. No.: US 2015/0168931 A1
(43) Pub. Date: Jun. 18, 2015

(54) SYSTEM FOR CONTROLLING LIGHTING AND SECURITY BY USING SWITCH DEVICE HAVING BUILT-IN BLUETOOTH MODULE

(71) Applicant: Kwang-Hone JIN, Youngdeungpogu Seoul (KR)

(72) Inventor: Kwang-Hone Jin, Seoul (KR)

(21) Appl. No.: 14/418,097

(22) PCT Filed: Dec. 13, 2013
(86) PCT No.: PCT/KR2013/011618

§ 371 Date: Jan. 29, 2015

(30) Foreign Application Priority Data
Jan. 10, 2013 (KR) 10-2013-0002734

(51) Int. Cl. G05B 15/02; H04W 4/00

(52) U.S. Cl. CPC G05B 15/02; H04W 4/008

(57) ABSTRACT

Disclosed is a system for controlling lighting and security. The system uses a switch device which has a built-in Bluetooth module. The system turns power applied to various kinds of home appliances and convenience facilities on or off. The system automatically turns lighting provided at an underground parking lot, corridors and the like of a building on or off. The system transmits a signal by detecting trespassing into the building.

### CROSS REFERENCE TO PRIOR APPLICATIONS

This application is a National Stage Patent Application of PCT International Patent Application No. PCT/KR2013/011618 filed on Dec. 13, 2013 under 35 U.S.C. §371, which claims priority to Korean Patent Application No. 10-2013-0002734 filed on Jan. 10, 2013, which are all hereby incorporated by reference in their entirety.

### BACKGROUND

The present invention relates to a system for controlling light and security by using a switch device having a built-in Bluetooth module, and more particularly, to a system for controlling lighting and security by using a switch device which has a built-in Bluetooth module, turns power applied to various kinds of home appliances and convenience facilities on or off, automatically turns lighting provided at an underground parking lot, corridors and the like of a building on or off, and transmits a signal by detecting trespassing into the building.

Generally, more and more LED lamps are being used instead of fluorescent lamps in order to save power applied to various lighting devices. In line with this trend, various products for reducing power are being introduced. However, the power consuming effects are not significant due to various fundamental problems.

In the case of lighting systems using LED, which are installed in parking lots, installation is complicated, a separate system including a personal computer (PC), hardware (H/W), a controller, etc. is needed, and the existing electric wiring needs to be changed or additional wiring construction is needed. However, obtaining power consumption reduction effects through such processes is inefficient and the construction costs increase. Further, currently, in order to enhance power saving effects, some products which reduce by consumption by using lighting lamps having a built-in wireless communication functions such as a dimming circuit or a Zigbee, but they increase costs, thereby lowering the return on investment (ROI). ROI period of LED light lamps installed in parking lots is usually 3 to 5 years. However, this is the case when communication functions and control functions are installed inside LED lighting lamps, and only LED lighting lamps are controls so that the efficiency of various applications linked with glow lamps, fluorescent lamps, LED lamps, etc. is deteriorated. Further, controlled objects are limited to LED lighting lamps, etc., and thus application to various products is not being done. That's why it is difficult to apply to various products despite advantages of LED lighting lamps such as light efficiency and a long lifespan.

Further, separately installing lighting lamps and security facilities for security of buildings has been generalized. This generates dual costs, and a surveillance camera, etc. needs to be operated 24 hours a day so that unnecessary energy is continually consumed. Further, a separate switch needs to be installed in order to control switches installed in new buildings through piping and wiring work, which increases the costs.

Further, a lot of power consumption technologies are being applied to reduce unnecessary power consumption in a building and a parking lot. LED lighting lamps frequently use a scheme of reducing power consumption by lowering or adjusting the brightness of lighting of a parking lot through a dimming control. However, this is not a fundamental solution and about 50% or more unnecessary power is being consumed. Further, in an area where lighting has been installed, a system for turning on a lamp when a vehicle or a person enters the area and turning off the lamp when a vehicle or a person leaves the area by applying a device which communicates with RFID, but every user of the building and the parking lot needs to have an ID card, and lighting is turned off after a predetermined period of time and thus the user may wander about in the darkness.

Further, a scheme of locally turning on or off some lamps in a parking lot by adding a human body sensor in an LED lamp in the form of being unconditionally turning off the lamp after a predetermined time after turned on when a person is sensed is being used, but when such an LED lamp is installed in the parking lot, it is difficult to completely determine the existence of a person, and the power consumption reduction effects are limited to the local area. Further, LED lamps, which are installed in an underground parking lot or corridors, have about 50% power-saving effects compared to the existing fluorescent lamps, but they are in the turned-on state even when there is no person around, which lowers the power-saving effects.

### PRIOR ART LITERATURE

### Patent Literature

(Patent literature 0001) Korean Patent Publication No. 10-2011-0085437

(Patent literature 0002) Korean Patent No. 10-1165364

(Patent literature 0003) Korean Patent No. 10-1110173

(Patent literature 0004) Korean Patent No. 10-1001276

(Patent literature 0005) Korean Patent Publication No. 10-2008-0081517

(Patent literature 0006) Korean Patent Publication No. 10-2011-0055807

(Patent literature 0007) Korean Patent Publication No. 10-2012-0097237

(Patent literature 0008) Korean Patent Publication No. 10-2003-0009926

(Patent literature 0009) Korean Patent Publication No. 10-2004-0018874

(Patent literature 0010) Korean Patent Publication No. 10-2010-0050685

(Patent literature 0011) Korean Patent Publication No. 10-2009-0019827

(Patent literature 0012) Korean Patent Publication No. 10-2009-0064878

(Patent literature 0013) Korean Patent Publication No. 10-2011-0103124

(Patent literature 0014) Korean Patent Publication No. 10-2011-0037107

(Patent literature 0015) Korean Patent No. 10-1100228

(Patent literature 0016) Korean Patent Publication No. 10-2010-0135306

(Patent literature 0017) Korean Patent Publication No. 10-2012-0042346

(Patent literature 0018) Korean Patent Publication No. 10-2011-0073040

(Patent literature 0019) Korean Patent Publication No. 10-2009-0076292

(Patent literature 0020) Korean Patent Publication No. 10-2011-0118783

(Patent literature 0021) Korean Patent No. 10-1034957

(Patent literature 0022) Korean Patent Publication No. 10-2005-0086326

(Patent literature 0023) Korean Patent Publication No. 10-2012-0036778

(Patent literature 0024) Korean Patent Publication No. 10-2008-0073994

(Patent literature 0025) Korean Patent Publication No. 10-2011-0017698

(Patent literature 0026) Korean Patent Publication No. 10-2009-0121171

### SUMMARY

An object of the present invention is to turn on or off a device for security or a lamp by a switching device by establishing a wireless network by having various built-in sensor modules and Bluetooth modules in order to wirelessly and automatically control a plurality of lighting lamps or devices for security.

Further, another object of the present invention is to allow a user to use a mobile terminal or a personal computer in order to control the switching device and performing a setting for the control.

Further, another object of the present invention is to power-saving effects and convenience and reliability of management in connection with a management system, a security system, and a parking monitoring system of a building where the switching device has been installed.

The present invention provides a system for controlling lighting and security using a switch device having a built-in Bluetooth module, including switch devices 100 to 108 including a sensor module 110 which senses a human body or an object and the intensity of light and captures an image, a control module 120 which outputs a control signal by computing and determining a signal which is inputted from the sensor module 110, a switching module 130 which turns on or off one or lighting lamps 160 to 162 and security equipment 410 with a control signal of the control module 120, a Bluetooth module 150 which transmits and receives a wireless signal with a control signal of the control module 120, and a power module 140 which supplies power needed in operating the sensor module 110, the control module 120, the switching module 130, and the Bluetooth module 150; and a relay switch device 200 which includes the sensor module 110, the control module 120, the Bluetooth module 150, and the power module 140, and relays a wireless data signal.

The sensor module 110 may include a pyroelectric infrared ray (PIR) sensor 111 for sensing a human body, a microwave sensor 112 for sensing an object, a CMOS image sensor or CCD image sensor 113 for sensing and capturing an image, and selectively an optical sensor 114 for sensing the intensity of light or an illumination sensor 115 for sensing density of light flux.

The control module 120 and the Bluetooth module 150 may be composed of one chip or respective single chips.

The switching module 130 may include a TRIAC 131, a DIAC 132, or a semiconductor device (MOSFET) 133 for switching an electric signal, the lighting lamps 160 to 162 include a fluorescent lamp, a glow lamp, a mercury lamp, a natrium lamp, and a halogen lamp, and the security equipment 410 may include a monitoring camera or an alarm including a CCTV camera or an infrared camera. The power module 140 selectively may include a power supply device (SMPS), a solar battery, or a battery. The relay switch device 200 may include an on/off switch which can be manually switched. The Bluetooth module 150 may turn on or off respective switch devices 100 to 108 individually or by groups or transmit information for controlling dimming through a wireless data communication between the switch devices 100 to 108 and the relay switch devices 200, and the switch devices 100 to 108 and the relay switch device 200 may set and change a value for operating the switch devices 100 to 108 through a wireless data communication with a mobile terminal 500 or a personal computer 510 having a Bluetooth communication function.

The control module 120 of the switch devices 100 to 108 and the relay switch device 200 may bind a unique identification number of switch devices 100 to 108 when transmitting a wireless signal in a Bluetooth module 150+a count value of the number of times of transmission+a mask bit+a unique service identification number+a data length within 1,000 bytes+data within 1,000 bytes as one packet and turn on or off lighting lamps 160 to 162 or security equipment 410 individually, by groups, or entirely. Each of the switch devices 100 to 108 may selectively use a passcode within 1,000 bytes for allowing connection to wireless data communication between the switch devices or between the switch devices 100 to 108 and the mobile terminal 500.

The control module 120 may include a plurality of service process algorithms composed of a binary-coding program for one or more unique service processes and include the unique service identification number for processing a wireless data signal in the service process algorithm, one or more service process algorithms may be connected to the one unique service identification number, a plurality of vector tables may be applied for replacement of the plurality of service process algorithms, and the record of each of the vector tables may include a universal unique identifier (UUID), which is a unique switch identification number of the service process algorithm, and a start address of the service process algorithm.

The sensor module 110 may sense a movement or motion of a human body from a certain distance, the sensed signal may be transmitted to the control module 120, the control module 120 may turn on or off the switch devices 100 to 108 and process dimming control on the basis of a preset value and a service process algorithm, the sensed signal may be transmitted to the outside through the Bluetooth module 150 as a wireless data signal, and some of the switch devices 100 to 108 may redundantly receive the wireless data signal.

The switch devices 100 to 108 may set to allow or block the relay for a unique service number in the received packet, a service identification number stored in the switch devices 100 to 108, and a setting state of a flag bit with binary-coded 0 and 1 so as to determine whether to relay.

The control module 120 may remove unnecessary signals from one image collected in an image sensor 113 included in the sensor module 110 in order to determine a minute movement of a human body and then remove a brightness portion from a base frame, form a frame in bit units by performing binary-coding color information with the average of frequency so as to consecutively obtain 2 to 3 frames per second, average pixel bit values of the most recently obtained frame and the previous obtained frame so as to be compared, in which the whole or part of the obtained frames is made as specific areas so as to be compared, and a phase only correlation, which allow easy comparison of a shaking, getting twisted, and screen tilt of the obtained frames, is selective applied for comparison. The switch devices 100 to 108 may be composed of a network of a mesh or star topology form and displays a human body sensing state, sensing time, and a sensing path through the screen of the mobile terminal 500 or the personal computer 510 from a signal which has been relayed through information on whether switch devices, which have sensed a human body or an object, perform relay and transmission.

According to the present invention, when a person or a vehicle is sensed, a lighting lamp is automatically turned on or off or security equipment is operated so that unnecessary power consumption may be reduced, thereby minimizing the costs according to operation of lighting lampas and security equipment and enhancing reliability according to operation of lighting lamps and security equipment.

### BRIEF DESCRIPTION OF THE DRAWINGS

FIG. 1 is a block diagram illustrating a switching device having a built-in Bluetooth module according to an embodiment of the present invention.

FIG. 2 illustrates an example of a security control system and lighting using a switching device having a built-in Bluetooth module according to the present invention.

FIG. 3 illustrates transmission of a signal in a security control system and lighting using a switching device having a built-in Bluetooth module according to the present invention.

FIG. 4 illustrates redundant transmission of a signal in a security control system and lighting using a switching device having a built-in Bluetooth module according to the present invention.

FIG. 5A illustrates a packet which is transmitted in a switching device having a built-in Bluetooth module according to the present invention, and FIG. 5B illustrates a service identification number and a mask bit in a switching device having a built-in Bluetooth module according to the present invention.

FIGS. 6A to 6C illustrate an example of application of a switching device having a built-in Bluetooth module according to the present invention.

### DETAILED DESCRIPTION

Hereinafter, a system for controlling lighting and security by using a switch device which has a built-in Bluetooth module will be described with reference to the attached drawings.

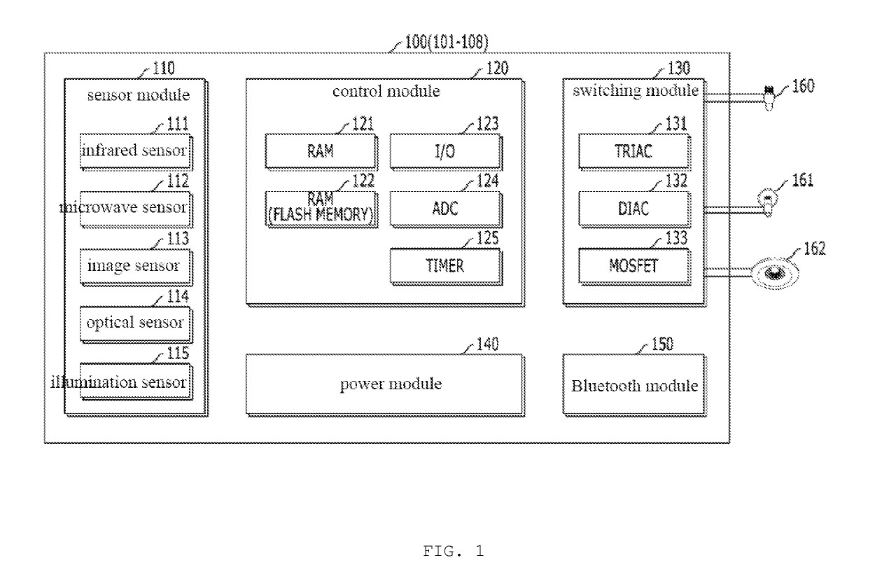

In FIG. 1, a switching device 100 is connected to a plurality of light lamps and security equipment so as to switch operation of the lighting lamp and security equipment, transmit wireless data signals to one or more switching devices or receive wireless data signals from one or more switching devices. The switching device 100 includes a sensor module 110, a control module 120, a switching module 130, a Bluetooth module 150, and a power module 140. A plurality of switching devices 100 form a series of Bluetooth communication networks. The switching device 100 has functions of sensing an object, turning on/off a lighting lamp and security equipment, and relaying a wireless data signal.

The sensor module 110 includes various kinds of sensors capable of respectively sensing various situations or conditions. The sensor module 110 a pyroelectric infrared ray (PIR) sensor 111 for sensing a human body, a microwave sensor 112 for sensing an object, a CMOS image sensor or CCD image sensor 113 for sensing and capturing images, an optical sensor for sensing the intensity of light, and an illumination sensor for sensing the density of the light flux. The sensors included in the sensor module 110 may be added or reduced depending on the installation position or function of the switch device 100.

The infrared sensor 111 included in the sensor module 110 may be controlled to input a signal at a high or low state to the control module 120 after amplifying the signal to a certain level by using an amplifier (OP Amp) due to a low signal level or to determine the point of time of turning on or off the switch device 100 by a programming algorithm which is built in the control module 120 through an analog to digital converter (ADC).

The control module 120 outputs a control signal to the switching module 130 or the Bluetooth module 150 after computing and determining a signal inputted from the sensor module 110. The control module 120 includes a RAM 121, a ROM 122, a flash memory, an input/output unit (I/O) 123, an analog to digital converter (ADC) 124, and a timer 125. The control module 120 may be composed of one chip.

The switching module 130 turns on or off one or more lighting lamps or security equipment connected to the switching module 130 with a control signal of the control module 120. The switching module 130 includes a device for switching an electric signal, such as TRIAC, DIAC, and MOSFET. The lighting lamps may include a fluorescent lamp, a glow lamp, a mercury lamp, a natrium lamp, and a halogen lamp. The security equipment may include a monitoring camera or an alarm including a CCTV camera or an infrared camera. Further, the switching module 130 supplies or blocks commercial power (AC85V to 250V) applied to lighting lamps or security equipment or controls dimming by using a pulse width modulation (PWM) control, i.e., adjusts the value outputted to the lighting lamps or security equipment. Further, zero crossing switching or the dimming control using TRIAC or DIAC may be selectively applied on the basis of the starting point of the supply frequency when the commercial power is turned on or off. The Bluetooth module 150 transmits and receives a control signal of the control module 120 as a wireless signal, a signal of the bandwidth of 2.4 GHz. The Bluetooth module 150 converts a detection signal of the sensor module 110 into a control signal in the control module 120 so as to wirelessly transmit data to an adjacent Bluetooth module 150 or receive wireless data from and adjacent Bluetooth module 150. The Bluetooth module 150 may be composed of one chip. Further, the control module 120 and the Bluetooth module 150 may be respectively composed of one independent chip or the two modules may be composed of one chip. Further, the Bluetooth module 150 may be set to turn on or off switching devices 100 respectively or by groups, and mutual information data is shared for dimming control.

The power module 140 supplies power which is needed in operating the switching device 100. That is, externally applied alternating current AC is converted into direct current DC for operating the switching device 100 so as to supply power which is needed in respective components. The power module 140 includes a switching mode power supply (SMPS) and a battery which can store power supplied from the SMPS or power supplied from new renewable energy such as a solar battery and later supply power which is needed in operating the switching device 100.

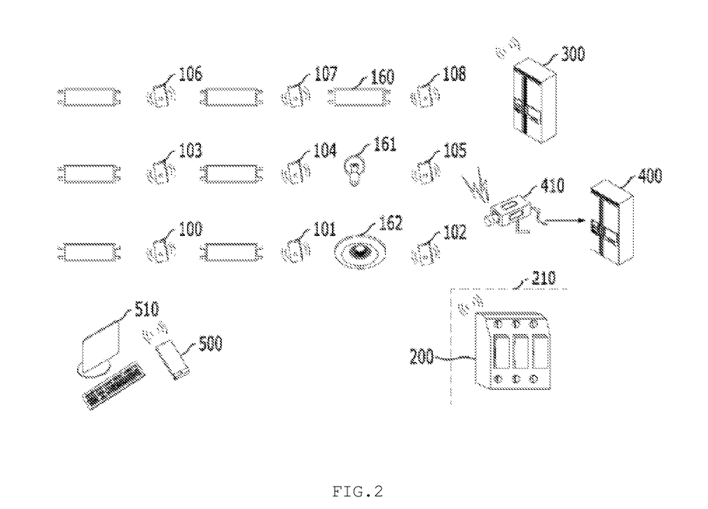

Further, in FIG. 2, a relay switch device 200, which is installed on the well, the ceiling, or the desk, may be supplied power directly from a solar battery or a battery which supplies direct current DC. Further, the switching device 100 has an additional unique switch identification number of 1 byte or more separately from the MAC address of the Bluetooth. The unique identification number may be used by combining the line number and the row number for the convenience of identification. For example, the row may be indicated by English alphabets and the line may be indicated by numbers, or in the opposite way, the row may be indicated by numbers and the line may be indicated by English alphabets. Further, the row may be indicated by capital letters of English alphabets and the line may be indicated by small letters of English alphabets, or the row may be indicated by small letters of English alphabets and the line may be indicated by capital letters of English alphabets.

Further, in FIG. 2, the relay switching device 200 is obtained by omitting the switching module 130 from the configuration of switching devices 101 to 108 including the same configuration and function as that of the switching device 100. The relay switching device 200 is installed on a ceiling, a wall, or a desk and receives an on or off signal which is directly operated by the user or senses an object and transmits the detection signal to adjacent switch devices 100 to 108 or the relay switch device 200. That is, the relay switch device 200 includes a function of relaying wireless data signals between a plurality of switch devices 100 to 108 and another adjacent relay switch device 200 along with the sensing of an object.

Hence, a plurality of switch devices 100 to 108 or a relay switch device 200 may be selectively installed in the corridors, underground parking lot, or entrance of the building. Further, the switching device 100 is connected to lighting lamps 160 to 162 or security equipment 410 including a surveillance camera and wirelessly transmits or receives a detection signal to adjacent switch devices 100 to 108 or relay switch device 200 along with operating the lighting lamps 160 to 162 or security equipment 410. Further, the relay switch device 200 is not connected to the lighting lamps or security equipment and wirelessly transmits or receives a detection signal to or from adjacent switch devices 100 to 108 or relay switch device 200. A series of Bluetooth communication networks are formed in the plurality of switch devices 100 to 108 and the relay switch device 200. The lighting lamps include a first lighting lamp 160 corresponding to a fluorescent light connected to a switch device, a second lighting lamp 161 corresponding to a glow lamp connected to a switch device, and a third lighting lamp corresponding to a halogen lamp connected to a switch device, and also includes an LED lamp connected to a switch device.

Further, a mobile terminal 500 and a computer terminal capable of remotely setting data of the switch devices 100 to 108 or relay switch device 200 are prepared. The mobile terminal 500 and the computer terminal 510 may include a program or application for setting data and include a function of Bluetooth communication with the switch devices 100 to 108 and the relay switch device 200.

The building management and control system server 300 receives and stores wireless data signals which are generated, relayed, and inputted in a plurality of switch devices 100 to 108 and the relay switch device 200 which are installed in a building, computes and determines the received data signals and outputs control signals as wireless data signals. At this time, control signals will be transmitted to the plurality of switch device 100 to 108 and the relay switch device 200 as wireless data signals in the order of transmission of wireless data signals which have been transmitted to the building management and control system server 300 via the plurality of switch devices 100 to 108 and the relay switch device 200 and in the opposite order thereof.

The security system server 400 is connected to a plurality of sets of security equipment and alarm devices and receives and stores images captured in the image sensor 113 included in the sensor module of the switch devices 100 to 108 and the relay switch device 200 and the images captured in the security equipment, i.e., the monitoring camera. Further, the security system server 400 may receive and store an image signal and an alarm signal from the already installed plurality of sets of security equipment 410 and alarm devices via the switch device and the relay switch device, but may receive and sore image signals from the image sensor included in the sensor module of the plurality of switch devices and the relay switch device. The security equipment 410 may be installed in the underground parking lot, corridors, or elevator of a building, and each set of security equipment transmits and receives wireless data signals to or from the security system server 400 via the switch device and the relay switch device.

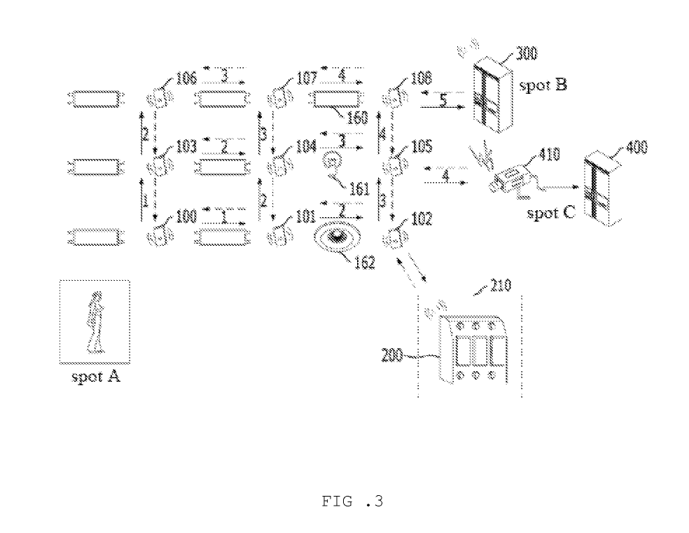

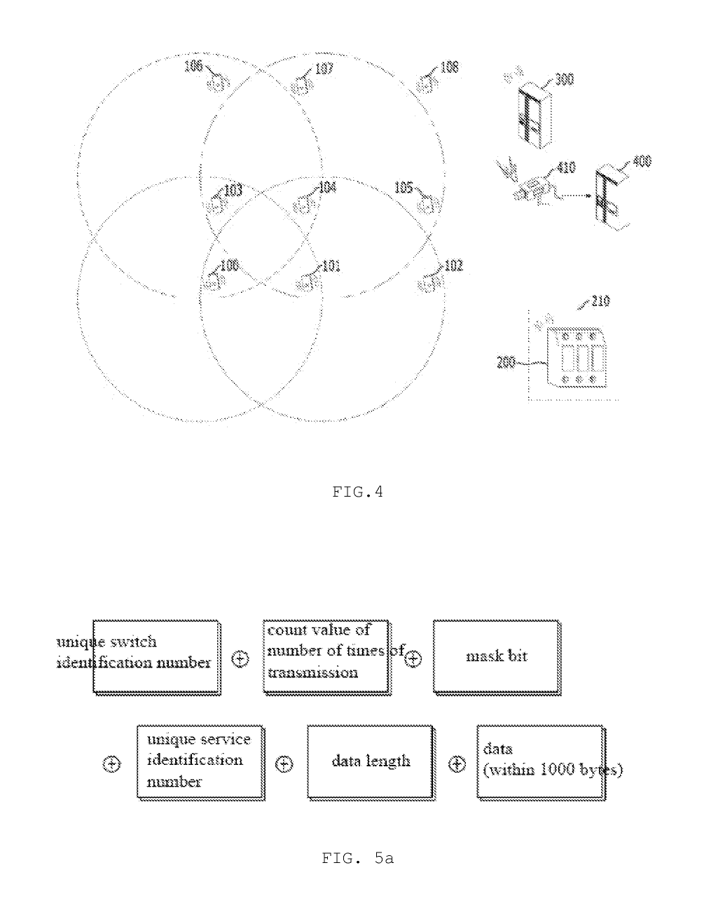

In FIG. 3, a flow of a wireless data signal for controlling lighting and security using a system for controlling lighting and security using a switch device having a built-in Bluetooth module according to the present invention will be described. A data signal is transmitted from the switch device 100 at spot A to the building management and control system sever 300 at spot B or the security system server 400 at spot C via the plurality of switch devices 101 to 108 and the relay switch device 200 in a forward direction (straight line). Here, if a person or an object such as vehicle appears at spot A, the sensor module 110 of the switch device 100 senses the appearance, then turns on the lighting lamp connected to the switch device 100 and the image sensor captures an image. The switch device 100 transmits the sensed signal to the adjacent switch device 101 or 103 as a wireless data signal. The switch device 101 or 103, which receives a wireless data signal in the switch device 100, transmits the wireless data signal to an adjacent switch device 102, 104, or 106, and finally the building management and control system server 300 receives and stores the signal. At this time, the switch devices 101 to 108 load the received wireless data signal and the signal sensed by the switch devices 101 to 108 themselves and transmit the signal as a wireless data signal. Hence, the building management and control system server 300 analyzes the received wireless data signal and classifies and stores the sensed signal of the corresponding switch device. Further, in the signal transmission system of the switch devices 100 to 108, the plurality of relay switch devices 200 also relay the signals of the switch device.

Further, the information on the image, which is captured in the image sensor 113 included in the sensor module 110 of the switch devices 100 to 108, is relayed in respective switch devices 100 to 108 and the relay switch device 200 so as to be transmitted to the security system server 400 so as to be stored. Further, the security system server 300 also receives and stores the information on the image captured in separately installed security equipment 410.

Further, the building management and control system server 300 at spot B or the security system server at spot C transmits a control signal to the switch device 100 at spot A in the opposite direction (spotted line) as a wireless data signal. Here, if the building management and control system server 300 transmits the control signal to the switch device 108, the switch device 108 retransmits the control signal to an adjacent switch device 105 or 107, and the switch device 105 or 107 again transmits the control signal to an adjacent switch device 102, 104, or 106 as a wireless data signal so as to be finally transmitted to the switch device 100 which is the final terminal. At this time, the switch devices 100 to 108, which become the control subject included in the corresponding control signal during the transmission and relay as the wireless data signal, perform an operation or response to the control signal.

Further, in the signal transmission system of the switch devices 100 to 108, a plurality of relay switch devices 200 also relay the signal of the switch device.

Further, the security system server 400 also performs transmission of information about security or setting information through adjacent switch devices 100 to 108.

Further, in FIG. 3, the unique switch identification number is transmitted to surrounding switch devices 100 to 108 and/or the relay switch device 200 by transmitting the unique switch identification number and the count value of the number of times of the transmission within about 1000 bytes as wireless signals in order to avoid redundant transmission which may occur in the process of transmitting wireless signals. At this time, with respect to the count value of the number of times of transmission, when movement of an object is sensed or a situation for transmitting a wireless signal such as an on or off input of the relay switch device 200 attached on the wall occurs, the switch device 100, at which such a situation occurs first, sets the count value as 0 so as to be transmitted, and the adjacent switch devices 101 and 103, which have received this wireless signal, retransmit the wireless signal after increasing the value by 1. Through the repetition of the above process, all switch devices, which form the Bluetooth communication network, transmit a related signal or receive a signal needed to the switch device itself.

Further, some of the switch devices 100 to 108, i.e., the switch devices 102, 104, 106, 107, and 108 redundantly receive the same wireless signal. At this time, the switch devices, which receive the wireless signals, compare the previously received count value and process only the signal of the smallest count value. Further, the scheme of reducing the count value may also be used. Hence, the process of redundantly transmitting the wireless signal may be prevented through the series of processes.

Further, the switch devices 100 to 108 may have various setting values and a unique service identification number composed of the minimum 1 byte in order to support the operating environment, and the service identification number may additionally include data such as the setting value of the minimum 1 byte. Further, the unique service identification number may have an execution code of the minimum 1 byte composed of a binary number which may be executed in the control module 120 for an additional service.

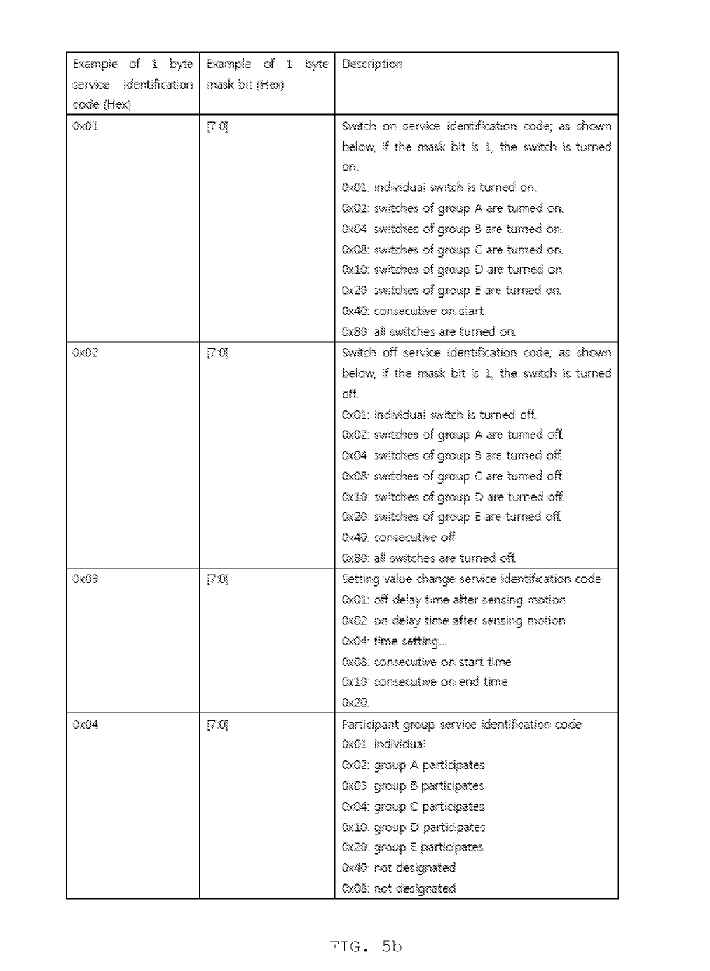

Further, in FIG. 5B, an algorithm for a corresponding service process is included in the control module 120 of the switch device 100 for the process of one or more services. That is, in the algorithm for the unique service process, the unique service identification number and a plurality of service algorithms have 1:1 or 1:N relation. That is, one unique service identification number and the plurality of service process algorithms include a bit map mask of 1 bit or more in 1:N relation. For example, in Ox01(Hex), the switch is turned on, and in 0x02(Hex), the switch is turned off. Further, the algorithm for the service process is formed and operated as a binary program in the form of a function. Further, the switch device may easily replace the algorithm by applying a vector table for easy replacement of the programmed algorithm. The number of records of the vector table coincides with the number of unique service process algorithms. Respective records of the vector table are formed of a universal unique identifier (UUID), which is the unique switch identification number of the service process algorithm, and the start address of the service process algorithm.

Further, if a movement of a human body or any motion is sensed, the sensor module 110 of the switch device 100 outputs a detection signal, and this detection signal is transmitted to the control module 120. Then the control module 120 turns on or off the switch device 100 or performs dimming control on the basis of the preset value and the service process algorithm. At this time, the detection signal is transmitted to the outside through the Bluetooth module 150 as the wireless data signal. Further, the switch devices 102, 104, 106, 107, and 108 redundantly receive the wireless data signal.

Further, respective switch devices 100 to 108 may use a unique service identification number within the received packet and a flag bit for determining whether to be transmitted in order to determine whether relay the received packet. 1:1 correspondence is made with the unique service identification number of 1 bit or more, and the switch device performs whether to relay with the unique service identification number, the service identification stored in the switch device, and the setting state of the flag bit with 0 and 1 which binary-coded, and the whether to be relayed is determined accordingly.

Further, the infrared ray sensor 111 of the sensor module 110 senses the infrared ray having the wavelength of about 830 nm so as to recognize the movement. This causes malfunction according to the air flow of different temperatures. Hence, in order to determine a more minute movement, unnecessary signals are removed from one image collected in the image sensor 113. Further, one image forms the frame in bit units by binary-coding the color information as the average of the frequency after moving the brightness part from the base frame. In this way, about 2 to 3 frames are consecutively obtained per second. Further, the pixel bit values of the most recently obtained frame and the previously obtained frame are averaged and compared. At this time, the whole or part of the obtained frame may be made as a specific area for comparison, and the phase only correlation may be selectively applied for comparison in the shaking, getting twisted, and the screen tilt. The pixel information of the frame may be compressed as one bit frame to maintain the same effects, the amount of data to be compared is reduced, the processing time, which is spent in comparison, is reduced, and the memory, which is needed in processing, may be saved.

Further, in the switching device 100 or the relay switch device 200, the sensor module 110, the control module 120, the Bluetooth module 150, the switch module 130, and the power module 140 may be selectively configured, and the detailed configuration of the module may also be selectively applied. Further, a tack switch, which allows manual manipulation by the user, is prepared in the switch device 100 or the relay switch device 200 so as to turn on or off the switch device.

That is, the lighting lamp or the security equipment may be turned on or off by using a wireless Bluetooth data signal which is generated by operation of a switch. Further, a solar battery panel and a secondary battery are prepared in the switch device so as to be attached on the wall, the ceiling, or the desk without additional wiring work.

Further, the switch devices 100 to 108 may be formed as a network of a mesh form or a star topology form and may display the human sensing state, the sensing time, the sensing path through the screen of the mobile terminal 500 or the personal terminal 510 in connection with the security equipment including a surveillance camera from a signal which has been relayed through information on the relay and transmission of the switch devices which have sensed the human body or an object.

Further, the switch devices 100 to 108 may have the mask bit of 1 byte or more in order to distinguish the type of a wireless signal which has been transmitted. The mask bit is used to distinguish whether the switch device, which has received the type and signal of data, is to use the received signal. For example, a mask bit is used to distinguish who has sent a signal in an adjacent switch device, a PC or smartphone, a security system, or a building management system and to determine whether the switch devices are to use the signal individually or all the switch devices are to use the switch device, whether it is to be used in group participation or whether the setting value is changed.

Hence, in the configuration showing the packet which is transmitted in the switch device having a built-in Bluetooth module of FIG. 5A, the switch devices 100 to 108 form the unique identification number+the count value of the number of times of transmission+the length of data of 1 byte or more+data of 1 byte or more as one packet so as to be transmitted. Such a method reduces the amount of data for data transmission in the Bluetooth communication network between switch devices and plays an important role in allowing a quick process.

The Bluetooth communication network and the local wireless network are known to allow the simultaneous connection of about 8 units between the wireless communication devices. The local wireless network uses the bandwidth of 2.4 GHz, etc., and thus maintaining the transmitted data less is a way to secure smooth wireless communication between the switch device and a smart terminal or other Bluetooth devices as well as between the switch devices. Further, in order to secure simultaneous connection between several Bluetooth devices, i.e., for the time sharing through the time slicing, respective switches perform N:N communication. At this time, in order to determine the connection priority between the switch devices, the switch device has the connection priority when connected using the switch's unique identification number. In more detail, first, a surrounding switch device is searched, and among the found switch devices, the connection priority is first given to the switch device having an identification number having the lower or highest row or line number among unique switch identification numbers. In the mutual connection between devices, each device has an inner list for connection, and after the first connection, in order to make the time until the next connection accurate, the switch device shares the system clock count value inside the control module and determines the connection time (meeting time) for wireless signal connection after a certain time passes, and thus the switch device, which becomes the basis, synchronizes time on the basis of the system block count value of the switch device having a low or high unique switch identification number.

When newly setting or directly changing the setting value of the switch device by using a mobile terminal 500 such as a smartphone, i.e, when intending to directly turn on or off the switch devices individually, by groups, or all together at one time, surrounding switch devices are searched by using a search button in the smartphone screen, then if the found switch devices are shown on the screen, the switch device is selected. At this time, the selected switch device repeats (flashes) the on/off two times or three times, thereby informing of the selection of the switch device.

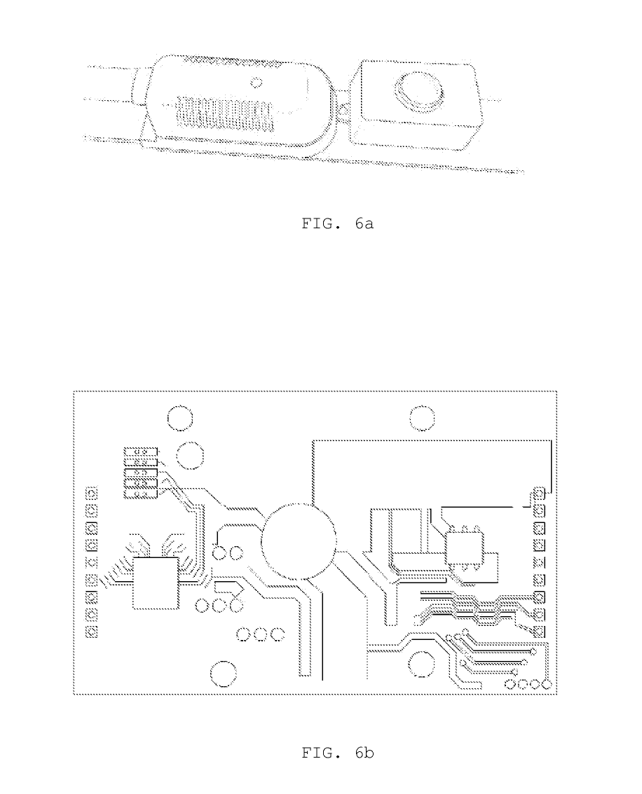

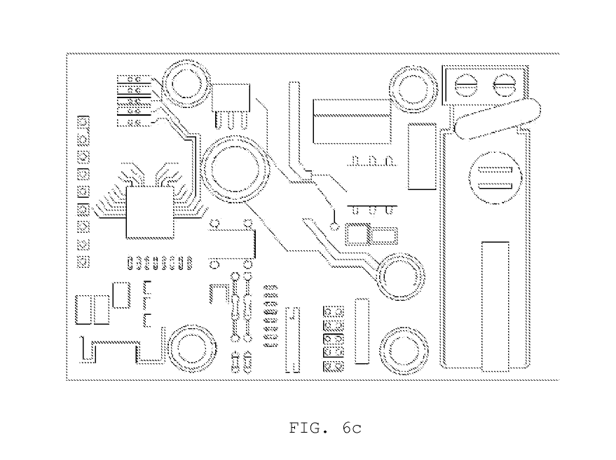

FIG. 6 illustrates a switch device having a built-in Bluetooth module of the present invention, FIG. 6A illustrates an example where switch devices 100 to 108 are connected to a lighting lamp, FIG. 6B illustrates an example of installation of a sensor module in switch devices 100 to 108 and a relay switch device 200, and FIG. 5C illustrates installation of a control module, a Bluetooth module, a power module, and a switching module on a circuit board.

After selecting a desired switch device through the above, the setting value change screen is used to change the setting value. After reading the predetermined value which is set in the switch device by using the setting value reading button of the smartphone, the value is displayed on the screen, and after the user changes the value and pushes the apply button, the setting value is transmitted to the switch device so as to be stored in the switch device, then the switch device flashes the lighting lamp about two or three times so as to complete storing the setting value. Hence, various setting values and the operation states of the switch device may be set and changed by using the above method, and the switch device, which is selected in the smartphone, may perform on/off control by groups or individually. Further, the switch device may be turned on or off conveniently if there is a mobile terminal at a user desired point of time regardless of the place (office desk, wall, etc.) through the above method.

The present invention was described and illustrated above with respect to specific embodiments, but it is easily understood by one of ordinary skill in the art that the embodiments may be modified and changed in various ways within the scope of the concept of the invention which is shown in the claims.

1. A system for controlling lighting and security using a switch device having a built-in Bluetooth module, the system comprising:
switch devices 100 to 108 including a sensor module 110 which senses a human body or an object and the intensity of light and captures an image, a control module 120 which outputs a control signal by computing and determining a signal which is inputted from the sensor module 110, a switching module 130 which turns on or off one or lighting lamps 160 to 162 and security equipment 410 with a control signal of the control module 120, a Bluetooth module 150 which transmits and receives a wireless signal with a control signal of the control module 120, and a power module 140 which supplies power needed in operating the sensor module 110, the control module 120, the switching module 130, and the Bluetooth module 150; and
a relay switch device 200 which includes the sensor module 110, the control module 120, the Bluetooth module 150, and the power module 140, and relays a wireless data signal,
wherein the relay switch device 200 relays and transmits and receives a wireless data signal of one or more adjacent switch devices 100 to 108 and the relay switch device 200, and
wherein the control module 120 of the switch devices 100 to 108 and the relay switch device 200 bind a unique identification number of switch devices 100 to 108 when transmitting a wireless signal in a Bluetooth module 150+a count value of the number of times of transmission+a mask bit+a unique service identification number+a data length within 1,000 bytes+data within 1,000 bytes as one packet and turn on or off lighting lamps 160 to 162 or security equipment 410 individually, by groups, or entirely.

2. The system of claim 1, wherein the sensor module 110 includes a pyroelectric infrared ray (PIR) sensor 111 for sensing a human body, a microwave sensor 112 for sensing an object, a CMOS image sensor or CCD image sensor 113 for sensing and capturing an image, and selectively an optical sensor 114 for sensing the intensity of light or an illumination sensor 115 for sensing density of light flux.

3. The system of claim 1, wherein the control module 120 and the Bluetooth module 150 are composed of one chip or respective single chips.

4. The system of claim 1, wherein the switching module 130 includes a TRIAC 131, a DIAC 132, or a semiconductor device (MOSFET) 133 for switching an electric signal, the lighting lamps 160 to 162 include a fluorescent lamp, a glow lamp, a mercury lamp, a natrium lamp, and a halogen lamp, and the security equipment 410 includes a monitoring camera or an alarm including a CCTV camera or an infrared camera.

5. The system of claim 1, wherein the power module 140 selectively includes a power supply device (SMPS), a solar battery, or a battery.

6. The system of claim 1, wherein the relay switch device 200 includes an on/off switch which can be manually switched.

7. The system of claim 1, the Bluetooth module 150 turns on or off respective switch devices 100 to 108 individually or by groups or transmits information for controlling dimming through a wireless data communication between the switch devices 100 to 108 and the relay switch devices 200, and the switch devices 100 to 108 and the relay switch device 200 set and change a value for operating the switch devices 100 to 108 through a wireless data communication with a mobile terminal 500 or a personal computer 510 having a Bluetooth communication function.

8. (canceled)

9. The system of claim 1, wherein each of the switch devices 100 to 108 selectively uses a passcode within 1,000 bytes for allowing connection to wireless data communication between the switch devices or between the switch devices 100 to 108 and the mobile terminal 500.

10. The system of claim 1, wherein the control module 120 includes a plurality of service process algorithms composed of a binary-coding program for one or more unique service processes and includes the unique service identification number for processing a wireless data signal in the service process algorithm, one or more service process algorithms are connected to the one unique service identification number, a plurality of vector tables are applied for replacement of the plurality of service process algorithms, and the record of each of the vector tables includes a universal unique identifier (UUID), which is a unique switch identification number of the service process algorithm, and a start address of the service process algorithm.

11. The system of claim 1, wherein the sensor module 110 senses a movement or motion of a human body from a certain distance, the sensed signal is transmitted to the control module 120, the control module 120 turns on or off the switch devices 100 to 108 and processes dimming control on the basis of a preset value and a service process algorithm, the sensed signal is transmitted to the outside through the Bluetooth module 150 as a wireless data signal, and some of the switch devices 100 to 108 redundantly receive the wireless data signal.

12. The system of claim 1, wherein the switch devices 100 to 108 sets to allow or block the relay for a unique service number in the received packet, a service identification number stored in the switch devices 100 to 108, and a setting state of a flag bit with binary-coded 0 and 1 so as to determine whether to relay.

13. The system of claim 1, wherein the control module 120 removes unnecessary signals from one image collected in an image sensor 113 included in the sensor module 110 in order to determine a minute movement of a human body and then remove a brightness portion from a base frame, forms a frame in bit units by performing binary-coding color information with the average of frequency so as to consecutively obtain 2 to 3 frames per second, averages pixel bit values of the most recently obtained frame and the previous obtained frame so as to be compared, in which the whole or part of the obtained frames is made as specific areas so as to be compared, and a phase only correlation, which allow easy comparison of a shaking, getting twisted, and screen tilt of the obtained frames, is selective applied for comparison.

14. The system of claim 1, wherein the switch devices 100 to 108 are composed of a network of a mesh or star topology form and displays a human body sensing state, sensing time, and a sensing path through the screen of the mobile terminal 500 or the personal computer 510 from a signal which has been relayed through information on whether switch devices, which have sensed a human body or an object, perform relay and transmission.
